(19) United States
(12) Patent Application Publication
(10) Pub. No.: US 2012/0321782 A1
(43) Pub. Date: Dec. 20, 2012

(54) METHOD AND APPARATUS FOR FABRICATING OPTICAL FILM

(75) Inventors: Kazuya Hada, Ibaraki-shi (JP); Satoshi Hirata, Ibaraki-shi (JP); Masakazu Mochizuki, Ibaraki-shi (JP); Seiji Kondo, Ibaraki-shi (JP)

(73) Assignee: NITTO DENKO CORPORATION, Ibaraki-shi, Osaka (JP)

(21) Appl. No.: 13/581,398

(22) PCT Filed: Mar. 22, 2011
(86) PCT No.: PCT/JP2011/056796

§ 371 Date: Aug. 27, 2012

(30) Foreign Application Priority Data
Mar. 24, 2010 (JP) 2010-068145

(51) Int. Cl. B05D 5/06; B05C 3/172

(52) U.S. Cl. 427/162; 118/419

(57) ABSTRACT

Disclosed is a method for fabricating an optical film, comprising a treatment step comprising: continuously feeding a film, while holding both transverse end portions of the film; and bringing a lower surface of the film into contact with a surface of a treatment liquid with which a treatment tank is filled, while continuously feeding the film. The method for fabricating a polarizing film in which bringing a liquid into contact with a film and transversely stretching the polymer film by a tenter method or the like can be performed at the same time using a small and simple fabricating apparatus.

### TECHNICAL FIELD

The invention relates to a method for fabricating an optical film for use in image display devices such as liquid crystal display devices, electroluminescence (EL) display devices, plasma displays (PDs), and field emission displays (FEDs) and to an apparatus for fabricating the same.

### BACKGROUND ART

Image display devices (especially, liquid crystal display devices) are produced using optical films such as polarizing films. In general, such polarizing films are fabricated by dyeing and uniaxially stretching a polyvinyl alcohol (PVA) film. When a PVA film is uniaxially stretched, a dichroic material (dye) adsorbed on the PVA molecule is oriented, so that a polarizing film is formed.

As the size, performance, and brightness of liquid crystal display devices increase, the size of polarizing plates for use therein increases, and at the same time, the optical properties and in-plane uniformity of polarizing plates are required to be improved. To obtain a large polarizing plate, it is necessary to uniformly stretch a PVA film used as a raw material for a polarizing film. Unfortunately, uniform stretching is a very difficult process, in which in-plane uniformity and optical properties tend to be degraded. For example, Patent Document 1 proposes a method including stretching a PVA film by a tenter method, while bringing the whole of the PVA film into contact with a liquid. Unfortunately, a bath is necessary for immersion of the PVA film in the liquid when it is brought into contact with the liquid. Therefore, this method tends to require a large fabricating apparatus. Additionally, in the tenter method, it is difficult to shift the PVA film vertically because of the structure of the tenter. Therefore, a combination of stretching by the tenter method and immersion of a PVA film in a bath, which are performed at the same time, requires a very complicated structure.

To solve these problems, therefore, Patent Document 2 discloses a method for fabricating a polarizing film in which bringing a liquid into contact with a hydrophilic polymer film and transversely stretching the polymer film by a tenter method or the like can be performed at substantially the same time using a small and simple fabricating apparatus.

Unfortunately, in this method, a spraying method is used to bring the liquid into contact with the polymer film, and therefore, unevenness may occur because it is difficult to uniformly spray the liquid on the surface of the polymer film. On the other hand, the liquid may be brought into contact by a coating method, but in such a case, there is a problem in which it is necessary to make a large coating device, which will increase fabricating cost.

### PRIOR ART DOCUMENTS

### Patent Documents

Patent Document 1: JP-A-2006-91374
Patent Document 2: JP-A-2009-63982

### SUMMARY OF THE INVENTION

### Problems to be Solved by the Invention

The invention has been made in view of the above problems, and an object of the invention is to provide a method for fabricating an optical film in which bringing a film into contact with a liquid and transversely stretching the film by a tenter method or the like can be performed at the same time using a small and simple fabricating apparatus, and to provide a fabricating apparatus for such a method.

### Means for Solving the Problems

As a result of a study on methods and apparatuses for fabricating optical films, the inventors have accomplished the invention based on the finding that the above problems can be solved using the features described below.

To solve the above problems, therefore, the method for fabricating an optical film of the invention comprises a treatment step comprising: continuously feeding a film, while holding both transverse end portions of the film; and bringing a lower surface of the film into contact with a surface of a treatment liquid with which a treatment tank is filled, while continuously feeding the film.

According to this method, the treatment liquid is brought into surface-contact with the lower surface of the film, when the film is treated, so that the lower surface of the film can be uniformly treated without unevenness. As a result, uneven treatment can be prevented, which would otherwise occur when a spraying method or a coating method is used, and therefore, for example, optical films with high in-plane uniformity of optical properties can be fabricated. In conventional coating methods, a large amount of a treatment liquid should be applied in order to increase the performance of the treatment of a film. In the invention, however, higher treatment performance can be provided simply by bringing a certain amount of a treatment liquid into surface-contact, so that the amount of the treatment liquid used can be reduced. When a large optical film is fabricated, a spraying or coating method requires a large spraying or coating device depending on the size of the film, but according to the invention, it is enough to simply change the size of the treatment tank. In the invention, therefore, there is a high degree of freedom for changing or modifying the apparatus, which makes it possible to keep fabricating cost low.

In the stated above, the treatment step preferably further comprises sequentially stretching the film in its transverse direction. According to this feature, the treatment of the film and transverse stretching of the film by a tenter method or the like can be performed at the same time.

In the method, the treatment liquid preferably has a viscosity of at most 100 mPa·s, and the relation B/A<18 (l/minute) is satisfied, wherein A represents the depth (mm) of the treatment liquid in the treatment tank, and B represents a speed (mm/minute) at which the film is fed. The treatment liquid in the treatment tank, which is in contact with the film, is allowed to flow as the film is fed. In the invention, the relation B/A<18 (l/minute) may be satisfied, wherein A represents the depth (mm) of the treatment liquid, and B represents a speed (mm/minute) at which the film is fed, so that the flow of the treatment liquid can be suppressed as much as possible. As a result, the surface in contact with the film can be kept stable, so that the occurrence of unevenness (shear-induced unevenness) on the lower surface of the film can be reduced.

When the viscosity of the treatment liquid is set at 100 mPa·s or less, the friction between the lower surface of the film and the treatment liquid can be reduced. As a result, the flow of the treatment liquid can be suppressed, which would otherwise occur due to the feeding of the film in contact with the treatment liquid, so that the occurrence of uneven treatment can be reduced.

The lower surface of the film brought into contact with the treatment liquid is preferably a region inside the holding parts located at both ends of the film.

The lower surface of the film brought into contact with the treatment liquid is preferably a region inside the holding parts located at both ends of the film. This feature makes it possible to adsorb the dichroic material to the lower surface of the film or to perform crosslinking.

The treatment liquid is preferably continuously supplied to the treatment tank. When the film is treated by continuously bringing the film into contact with the treatment liquid, the treatment efficiency may be reduced due to degradation of the treatment liquid over time. In this way, however, when the treatment liquid is continuously supplied to the treatment tank, degradation of the treatment liquid can be suppressed, which makes it possible to prevent the treatment efficiency reduction. As a result, optical films with high in-plane uniformity of optical properties can be fabricated.

In addition, to solve the above-mentioned problems, the apparatus for fabricating an optical film of the invention comprises: a plurality of pairs of holding parts for continuously feeding a film while holding both transverse end portions of the film so that the film is allowed to continuously pass through a certain treatment step; and a treatment tank filled with a treatment liquid for use in a certain treatment of the film, wherein the plurality of pairs of holding parts are arranged at certain intervals along the longitudinal direction of the film, each pair of holding parts are configured to transversely stretch the film by moving away from each other while feeding the film, and the treatment tank is placed below the film to be fed so that the film can be treated by bringing a lower surface of the film into contact with the treatment liquid.

According to the features, the treatment liquid is brought into surface-contact with the lower surface of the film being fed by the pairs of holding parts, when the film is treated, so that the lower surface of the film can be uniformly treated without unevenness. As a result, uneven treatment can be prevented, which would otherwise occur when a spraying method or a coating method is used, and therefore, for example, optical films with high in-plane uniformity of optical properties can be fabricated. In conventional coating methods, a large amount of a treatment liquid should be applied in order to increase the performance of the treatment of a film. In the invention, however, higher treatment performance can be provided simply by bringing a certain amount of a treatment liquid into surface-contact, so that the amount of the treatment liquid used can be reduced. When a large optical film is fabricated, a spraying or coating method requires a large spraying or coating device depending on the size of the film, but according to the invention, it is enough to simply change the size of the treatment tank. In the invention, therefore, there is a high degree of freedom for changing or modifying the apparatus, which makes it possible to keep fabricating cost low. In addition, according to the features, the treatment of the film with the treatment liquid and transverse stretching of the film by a tenter method or the like can be performed at the same time.

In the stated above, the apparatus preferably satisfies the relation B/A<18 (l/minute), wherein A represents the depth (mm) of the treatment liquid in the treatment tank, and B represents a speed (mm/minute) at which the film is fed. The treatment liquid in the treatment tank, which is in contact with the film, is allowed to flow as the film is fed. In the invention, the relation B/A<18 (l/minute) may be satisfied, wherein A represents the depth (mm) of the treatment liquid, and B represents a speed (mm/minute) at which the film is fed, so that the flow of the treatment liquid can be suppressed as much as possible. As a result, the surface in contact with the film can be kept stable, so that the occurrence of unevenness (shear-induced unevenness) on the lower surface of the film can be reduced.

In the stated above, the treatment tank preferably has a width smaller than the width of the film so that the lower surface of the film to be in contact with the treatment liquid is a region inside both ends of the film.

In the stated above, the apparatus preferably further comprises a treatment liquid supply unit for continuously supplying the treatment liquid to the treatment tank. In this way, however, when the treatment liquid is continuously supplied to the treatment tank, degradation of the treatment liquid over time can be suppressed, which makes it possible to prevent the treatment efficiency reduction. As a result, optical films with high in-plane uniformity of optical properties can be fabricated.

### Effect of the Invention

According to the invention, the surface of the treatment liquid is brought into surface-contact with the lower surface of the film being fed continuously, when the treatment step is performed, so that unevenness can be prevented, which would otherwise occur when a spraying or coating method is used. As a result, the film can be uniformly treated, which makes it possible to fabricate an optical film with high in-plane uniformity of optical properties. In addition, the amount of the treatment liquid used can be reduced, and even the fabrication of a large optical film can be made possible simply by changing the size of the treatment tank, which provides a high degree of freedom for changing or modifying the apparatus and makes it possible to kept fabricating cost low.

### BRIEF DESCRIPTION OF THE DRAWINGS

FIG. 1 is a schematic diagram showing an optical film-fabricating apparatus according to an embodiment of the invention;

FIG. 2 is a plan view showing how holding parts of the optical film-fabricating apparatus feed a film, while holding the film;

FIG. 3 is a partially magnified view of FIG. 2;

FIG. 4 is a plan view showing treatment tanks with different shapes in the optical film-fabricating apparatus;

FIGS. 5(a) to 5(c) show levels of unevenness of a polarizing film, from rank 0 to rank 2; and

FIGS. 6(a) to 6(c) show levels of unevenness of a polarizing film, from rank 3 to rank 5.

### MODE FOR CARRYING OUT THE INVENTION

An embodiment of the invention is described below with reference to the drawings.

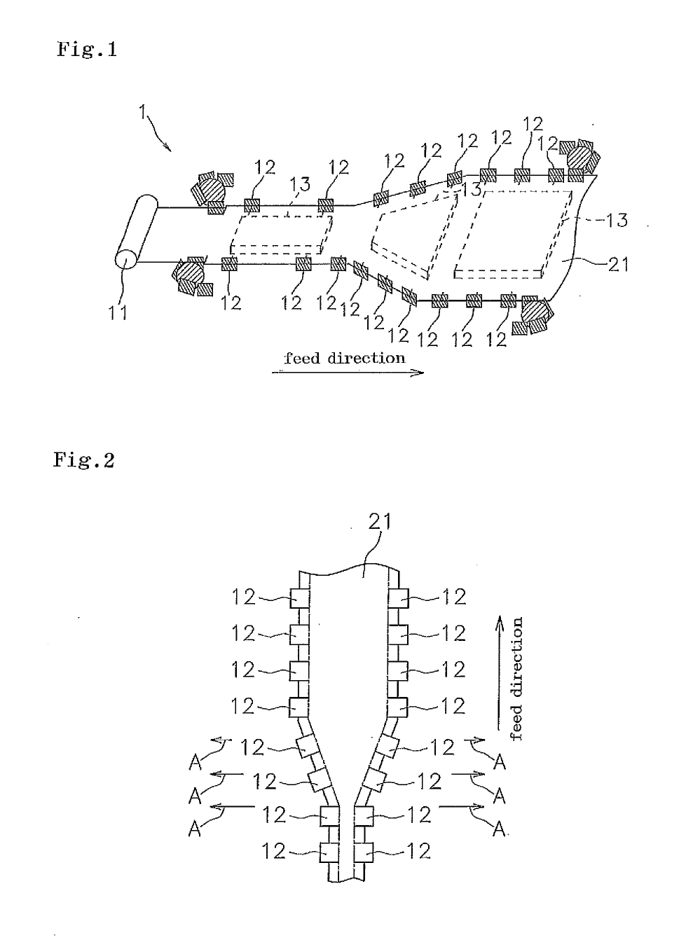

The optical film-manufacturing method according to the invention is described below with respect to a polarizing film as an example. A method according to an embodiment of the invention for fabricating a polarizing film includes at least a treatment step including bringing the lower surface of a film into contact with the surface of a treatment liquid with which a treatment tank is filled, while feeding the film continuously. For example, the method may be carried out using an optical film-fabricating apparatus 1 as shown in FIG. 1. The optical film-fabricating apparatus 1 includes at least a feed roll 11, a plurality of holding parts 12, a treatment tank 13, and a take-up roll (not shown).

The feed roll 11 and the take-up roll are provided to feed a film 21 and take up the film 21 being fed, respectively. The feed roll 11 and the take-up roll may also have the function of feeding in the direction indicated by the arrow in FIG. 1. In addition, the feed roll 11 and the take-up roll may apply a tensile force to the film 21 in the feed direction so that the film 21 can be kept stretched without slack.

The holding parts 12 can feed the film 21, while holding the film 21 at both transverse ends of the film 21. At the same time, as shown in FIG. 2, the holding parts 12 are preferably arranged opposite to each other so as to form each pair at both transverse ends of the film 21. This makes it possible to apply a tension to the film 21 evenly from both ends, even when the film 21 is transversely stretched using the holding parts 12.

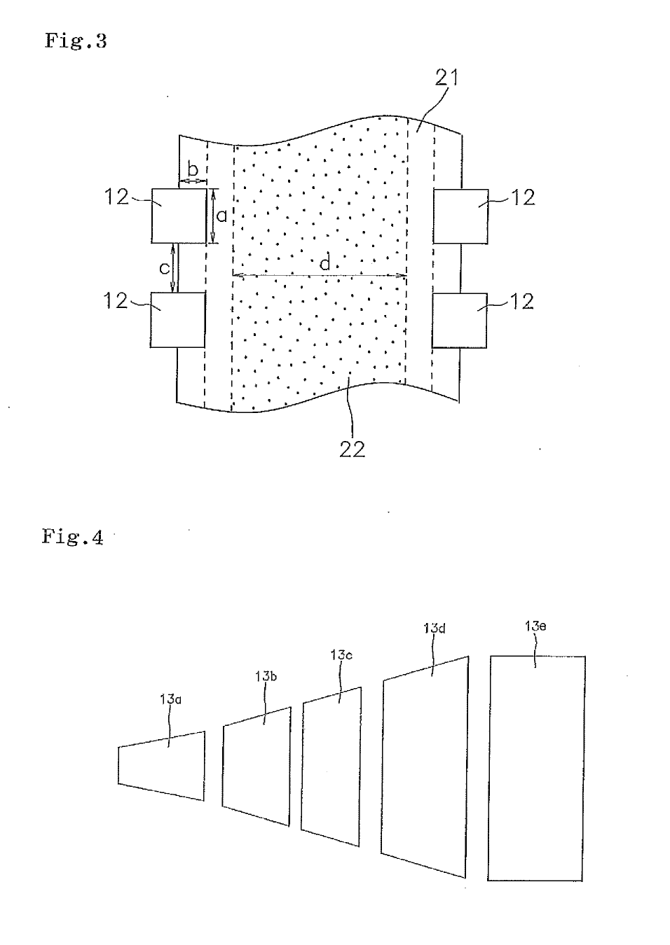

For example, the length (represented by “a” in FIG. 3) of the portion of the film 21 (the held portion) held by each holding part 12 is preferably, but not limited to, in the range of 10 to 100 mm, more preferably in the range of 10 to 75 mm, even more preferably in the range of 25 to 75 mm. For example, the width of the held portion (represented by “b” in FIG. 3) is preferably, but not limited to, in the range of 5 to 50 mm, more preferably in the range of 10 to 30 mm, even more preferably in the range of 10 to 20 mm. The width d of a region 22 to be treated by surface-contact with the treatment liquid is preferably in the range of 30 to 99% of the width of the film 21, more preferably in the range of 75 to 95% of the width of the film 21. In addition, two or more pairs of the holding parts 12 may be arranged at certain intervals along the longitudinal direction of the film 21. It should be noted that if the distance between the adjacent holding parts 12 is long, it may be difficult to achieve uniform transverse stretching of the film 21, so that the in-plane uniformity of optical properties may decrease. From such a point of view, the distance between the adjacent holding parts 12 (represented by “c” in FIG. 3) is preferably in the range of 1 to 20 mm, more preferably in the range of 3 to 10 mm, even more preferably in the range of 3 to 6 mm.

When the film 21 is transversely stretched, each pair of holding parts 21, which are opposed at both ends of the film 21, are preferably moved away from each other, while being moved in the feed direction. This makes it possible at the same time to feed the film 21 and to gradually stretch the film 21 transversely. For example, as indicated by the arrow A in FIG. 2, each pair of holding parts 12 may be so spaced that as they travel, they move away from each other at the same rate. Alternatively, one of them may travel straight in the feed direction, and the other may move away therefrom. When the holding parts 12 are used to feed the film 21, the holding parts 12 may be moved on rails so as to travel on predetermined lines (see FIG. 1). For example, the holding parts 12 may be tenter clips or others.

The speed B (mm/minute) of feeding of the film 21 is preferably in the range of 1 to 5,000 mm/minute, more preferably in the range of 300 to 3,000 mm/minute. When the feeding speed B is 1 mm/minutes or more, the polarizing film can be produced with higher productivity. On the other hand, when the feeding speed B is 5,000 mm/minute or less, shear-induced convection of the treatment liquid can be reduced.

The treatment tank 13 is filled with a treatment liquid (described in detail below) for use in the desired treatment of the film 21. The treatment tank 13 is so placed that the film 21 is fed through the upper side of it, and the lower surface of the film 21 comes in surface-contact with the treatment liquid in the treatment tank 13. This makes it possible to prevent uneven treatment, which would otherwise occur when a spraying or coating method is used, so that the lower surface of the film can be treated uniformly. In this process, the treatment liquid has a surface tension, and therefore, the lower surface of the film 21 may be separated from the upper side of the treatment tank by a distance within a certain range. Specifically, the distance between the lower surface of the film 21 and the upper side of the treatment tank is preferably in the range of 0 mm to 5 mm.

The depth A (mm) of the treatment liquid in the treatment tank 13 is preferably in the range of 1 mm to 500 mm, more preferably in the range of 35 mm to 200 mm. When the depth A of the liquid is 1 mm or more, the treatment liquid with which the treatment tank 13 is filled can have good conditions for surface-contact with the lower surface of the film 21. On the other hand, when the depth A is 500 mm or less, an excessive amount of use of the liquid can be reduced.

In addition, the relation B/A<18 (l/minute) is preferably satisfied, wherein A represents the depth (mm) of the treatment liquid with which the treatment tank 13 is filled, and B represents the speed (mm/minute) at which the film 21 is fed. This makes it possible to suppress the flow of the treatment liquid, which is caused by the contact with the film 21 being fed. As a result, the surface in contact with the film 21 can be kept stable so that unevenness (shear-induced unevenness) can be reduced.

The treatment liquid preferably has a viscosity of 100 mPa·s or less, more preferably 50 mPa·s or less, even more preferably 10 mPa·s or less. When the treatment liquid has a viscosity of 100 mPa·s or less, the friction between the lower surface of the film 21 and the treatment liquid can be reduced. As a result, the treatment liquid flow caused by the feeding of the film 21 in contact with the treatment liquid can be suppressed, so that the occurrence of uneven treatment can be reduced.

The treatment tank 13 may also be provided with a treatment liquid supply unit for continuously supplying the treatment liquid. This makes it possible to suppress a reduction in treatment efficiency, which is caused by degradation of the treatment liquid over time, so that the yield can be increased. The treatment liquid supply unit is typically, but not limited to, a unit capable of supplying the treatment liquid with a pump or the like.

Treatment tanks 13 with different shapes in planar view may be placed between the feed roll 11 and the take-up roll, depending on the stretch ratio at which transverse stretching is performed at the same time in each treatment step. For example, there are provided a treatment tank 13a for performing a swelling step, a treatment tank 13b for performing a dyeing step, a treatment tank 13c for performing a crosslinking step, a treatment tank 13d for performing a stretching step, and a treatment tank 13e for performing a control step (each of these steps is described in detail below). It should be noted that the treatment tanks 13a to 13e each preferably has a transverse size smaller than the width of the film 21. If the size is equal to or larger than the width of the film 21, the portions of the film held by the holding parts 12 may be softened or broken by contact with the treatment liquid.

Examples of the film 21 include, but are not limited to, a polymer film such as a polyvinyl alcohol-based film, a partially-formalized polyvinyl alcohol-based film, a polyethylene terephthalate-based film, an ethylene-vinyl acetate copolymer-based film, a partially-saponified film derived therefrom or a cellulose-based film; and a polyethylene-based oriented film such as a film of a dehydration product of polyvinyl alcohol or a dehydrochlorination product of polyvinyl chloride. In particular, a polyvinyl alcohol-based film is generally used, because in the dyeing step described below, iodine or a dichroic dye can be well oriented in it. It will be understood that the film 21 may have a laminated structure including two or more layers of the films listed above.

Polyvinyl alcohol (such as VF-9P75RS manufactured by KURARAY CO., LTD.) or a derivative thereof may be used as a material for the polyvinyl alcohol-based film. Examples of the polyvinyl alcohol derivative include polyvinyl formal, polyvinyl acetal and the like, and modifications of polyvinyl alcohol with an olefin such as ethylene or propylene, an unsaturated carboxylic acid such as acrylic acid, methacrylic acid, or crotonic acid, or an alkyl ester thereof, or acrylamide. The degree of polymerization of the polyvinyl alcohol-based polymer is preferably, but not limited to, in the range of 500 to 10,000, more preferably in the range of 1,000 to 6,000 in view of solubility in water or other properties. The polyvinyl alcohol-based polymer preferably has a degree of saponification of 75% by mole or more, more preferably in the range of 98 to 100% by mole.

The polyvinyl alcohol-based film may also contain an additive such as a plasticizer. Examples of the plasticizer include polyols and condensates thereof, such as glycerin, diglycerin, triglycerin, ethylene glycol, propylene glycol, and polyethylene glycol. The content of the plasticizer in the polyvinyl alcohol-based resin film is preferably, but not limited to, 20% by weight or less.

The film 21 in an unstretched state preferably has a width in the range of 10 to 1,000 mm, more preferably in the range of 400 to 550 mm. If the film has a width of less than 10 mm, the region to be coated may be lost due to the holding parts. On the other hand, if the width is more than 1,000 mm, a problem may occur in which the apparatus becomes too large, so that a large installation space is required.

For example, the thickness of the film 21 in an unstretched state is preferably, but not limited to, in the range of 15 to 110 μm, more preferably in the range of 38 to 110 μm, even more preferably in the range of 50 to 100 μm, in particular, preferably in the range of 60 to 80 μm. If the thickness of the film 21 is less than 15 μm, the film 21 may have too low mechanical strength so that it may be difficult to perform uniform stretching and that color unevenness may be more likely to occur when a polarizing film is fabricated. On the other hand, if the thickness of the film 21 is more than 110 μm, sufficient swelling may fail to be achieved, so that color unevenness may be enhanced in a polarizing film, which is not preferred.

There is no particular limitation on the treatment step that may be used in the polarizing film-fabricating method according to an embodiment of the invention. In general, a polarizing film can be fabricated by sequentially performing, on a PVA-based film, a swelling step, a dyeing step, a crosslinking step, a stretching step, a control step, and a drying step. Among these steps, the swelling step, the dyeing step, the crosslinking step, the stretching step, and the control step are each suitable for use as the treatment step in the optical film-fabricating method according to an embodiment of the invention. It will be understood that the invention may be carried out using all or at least one of these steps.

The swelling step may include bringing a PVA-based film as a raw film into contact with a swelling liquid. When this step is performed, the PVA-based film can be washed with water so that dirt and any anti-blocking agent can be washed away from the surface of the PVA-based film, and the PVA-based film is allowed to swell so that unevenness such as uneven dyeing can be prevented.

For example, water may be used as the swelling liquid. In addition, glycerin, potassium iodide, or the like may be added to the swelling liquid as needed. Glycerin is preferably added at a concentration of 5% by weight or less, and potassium iodide is preferably added at a concentration of 10% by weight or less. The swelling liquid preferably has a temperature in the range of 20 to 45° C., more preferably in the range of 25 to 40° C., even more preferably in the range of 30 to 35° C. In general, the time period for which the swelling liquid is brought into contact is preferably, but not limited to, 20 to 300 seconds, more preferably 30 to 200 seconds, in particular, preferably 30 to 120 seconds. The PVA-based film may also be transversely stretched while being in contact with the swelling liquid, and in such a case, the stretch ratio (including the ratio of elongation by swelling) is preferably from 0.5 to 3 times, more preferably from 1 to 2.5 times, even more preferably from 1.5 to 2 times the width of the unstretched film. When this step is not used as the treatment step in the invention, the method of bringing the PVA-based film into contact with the swelling liquid may be typically a method of immersing the film in the swelling liquid with which a swelling bath is filled, a method of applying the swelling liquid to the film, or a method of spraying the swelling liquid on the film. In these methods, the immersion time, the temperature of the swelling liquid, and the transverse stretch ratio may be appropriately set as needed.

The dyeing step may include bringing the PVA-based film into contact with an iodine-containing solution (a dyeing liquid) so that the iodine is adsorbed to the PVA-based film.

A solution of iodine in a solvent may be used as the dyeing bath solution. While water is generally used as the solvent, an organic solvent compatible with water may be further added to the bath solution. The iodine concentration is preferably in the range of 0.010 to 10% by weight, more preferably in the range of 0.020 to 7% by weight, in particular, preferably in the range of 0.025 to 5% by weight. To further increase the dyeing efficiency, an iodide is preferably added. Examples of such an iodide include potassium iodide, lithium iodide, sodium iodide, zinc iodide, aluminum iodide, lead iodide, copper iodide, barium iodide, calcium iodide, tin iodide, and titanium iodide. The content of the iodide in the dyeing bath is preferably from 0.010 to 10% by weight, more preferably from 0.10 to 5% by weight. In particular, potassium iodide is preferably added, and the ratio (weight ratio) between iodine and potassium iodide is preferably in the range of 1:5 to 1:100, more preferably in the range of 1:6 to 1:80, in particular, preferably in the range of 1:7 to 1:70.

In general, the time period for which the dyeing liquid is brought into contact is preferably, but not limited to, in the range of 10 to 200 seconds, more preferably in the range of 15 to 150 seconds, even more preferably in the range of 20 to 130 seconds. The dyeing liquid preferably has a temperature in the range of 5 to 42° C., more preferably in the range of 10 to 35° C., even more preferably in the range of 12 to 30° C. The PVA-based film may also be transversely stretched while being in contact with the dyeing liquid, and in such a case, the total stretch ratio is preferably from 1 to 4 times, more preferably from 1.5 to 3.5 times, even more preferably from 2 to 3 times the width of the unstretched film. When this step is not used as the treatment step in the invention, the method of bringing the PVA-based film into contact with the dyeing liquid may be typically a method of immersing the film in the dyeing liquid with which a dyeing bath is filled, a method of applying the dyeing liquid to the film, or a method of spraying the dyeing liquid on the film. In these methods, the immersion time, the temperature of the dyeing liquid, and the transverse stretch ratio may be appropriately set as needed.

In the crosslinking step, for example, the PVA film is brought into contact with a crosslinking liquid containing a crosslinking agent. The crosslinking agent to be used may be a known conventional material, examples of which include a boron compound such as boric acid or borax, glyoxal, and glutaraldehyde. These may be used singly or in combination of two or more. When these are used in combination of two or more, for example, a combination of boric acid and borax is preferred. The mixing ratio (molar ratio) between them is preferably in the range of 4:6 to 9:1, more preferably in the range of 5.5:4.5 to 7:3, most preferably 6:4.

A solution of the crosslinking agent in a solvent may be used as the crosslinking liquid. While water is typically used as the solvent, an organic solvent compatible with water may be further added to the bath solution. The concentration of the crosslinking agent in the solution is preferably, but not limited to, in the range of 1 to 10% by weight, more preferably in the range of 2 to 6% by weight.

An iodide may be added to the crosslinking liquid so that uniform optical properties can be obtained in the plane of the polarizing film. Examples of such an iodide include, but are not limited to, potassium iodide, lithium iodide, sodium iodide, zinc iodide, aluminum iodide, lead iodide, copper iodide, barium iodide, calcium iodide, tin iodide, and titanium iodide. The iodide content is preferably in the range of 0.05 to 15% by weight, more preferably in the range of 0.5 to 8% by weight. The iodides listed above may be used singly or in combination of two or more. When two or more of them are used in combination, a combination of boric acid and potassium iodide is preferred. The ratio (weight ratio) between boric acid and potassium iodide is preferably in the range of 1:0.1 to 1:3.5, more preferably in the range of 1:0.5 to 1:2.5.

In general, the temperature of the crosslinking liquid is preferably, but not limited to, in the range of 20 to 70° C., more preferably in the range of 20 to 40° C. In general, the time period for which the crosslinking liquid is brought into contact with the PVA-based film is preferably, but not limited to, in the range of 5 to 400 seconds, more preferably in the range of 50 to 300 seconds, even more preferably in the range of 150 to 250 seconds. The PVA-based film may also be transversely stretched while being in contact with the crosslinking liquid, and in such a case, the total stretch ratio is preferably from 2 to 5 times, more preferably from 2.5 to 4.5 times, even more preferably from 3 to 4 times the width of the unstretched film. When this step is not used as the treatment step in the invention, the method of bringing the PVA-based film into contact with the crosslinking liquid may be typically a method of immersing the film in the crosslinking liquid with which a crosslinking bath is filled, a method of applying the crosslinking liquid to the film, or a method of spraying the crosslinking liquid on the film. In these methods, the immersion time, the temperature of the crosslinking liquid, and the transverse stretch ratio may be appropriately set as needed.

For example, the stretching step may include transversely stretching the PVA film being in contact with a bath liquid such as an iodide-containing aqueous solution. The total stretch ratio is preferably from 3.5 to 6 times, more preferably from 4 to 5.75 times, even more preferably from 4.5 to 5.5 times the width of the unstretched film. The iodide to be used in the iodide-containing aqueous solution may be any of those listed above, and in particular, for example, potassium iodide, sodium iodide, or the like is preferred. When the aqueous solution is an aqueous potassium iodide solution, for example, its concentration is preferably in the range of 0.05 to 15% by weight, more preferably in the range of 0.5 to 8% by weight.

In general, the temperature of the bath liquid is preferably, but not limited to, in the range of 20 to 70° C., more preferably in the range of 20 to 40° C. The time period for which the bath liquid is brought into contact with the PVA film is preferably, but not limited to, in the range of 5 to 400 seconds, more preferably in the range of 50 to 300 seconds, even more preferably in the range of 150 to 250 seconds. When this step is not used as the treatment step in the invention, the method of bringing the PVA-based film into contact with the bath liquid may be typically a method of immersing the film in the bath liquid, a method of applying the liquid to the film, or a method of spraying the liquid on the film. In these methods, the immersion time and the temperature of the bath liquid may be appropriately set as needed.

For example, the control step may include bringing the film into contact with a control liquid such as an iodide-containing aqueous solution. The iodide to be used in the iodide-containing aqueous solution may be any of those listed above, and in particular, for example, potassium iodide, sodium iodide, or the like is preferred. Using the iodide-containing aqueous solution, a residue of boric acid, which has been used in the crosslinking step, can be washed away from the PVA-based film. When the aqueous solution is an aqueous potassium iodide solution, for example, its concentration is preferably in the range of 0.5 to 20% by weight, more preferably in the range of 1 to 15% by weight, even more preferably in the range of 1.5 to 7% by weight.

In general, the temperature of the control liquid is preferably, but not limited to, in the range of 15 to 40° C., more preferably in the range of 20 to 35° C. In general, the time period for which the control liquid is brought into contact with the PVA film is preferably, but not limited to, in the range of 2 to 30 seconds, more preferably in the range of 3 to 20 seconds. When this step is not used as the treatment step in the invention, the method of bringing the PVA-based film into contact with the control liquid may be typically a method of immersing the film in the control liquid with which a control bath is filled, a method of applying the control liquid to the film, or a method of spraying the control liquid on the film. In these methods, the immersion time and the temperature of the control liquid may be appropriately set as needed.

The drying step may be performed using an appropriate method such as natural drying, air drying, or drying by heating, in general, preferably using drying by heating. When drying by heating is performed, in general, the heating temperature is preferably, but not limited to, in the range of 25 to 60° C., more preferably in the range of 30 to 50° C., even more preferably in the range of 30 to 45° C. The drying time is preferably from about 1 to about 10 minutes.

The final total transverse-stretch ratio, which is reached for the polarizing film fabricated by performing each step as described above, is preferably 4 times or more, more preferably from 4.5 to 6 times the original width of the raw PVA film. If the final total stretch ratio is less than 4 times, the degree of polarization may fail to increase. When the total stretch ratio is kept at 6 times or less, the PVA film can be prevented from being ruptured.

A transparent protective film may be provided on at least one side of the polarizing film. A thermoplastic resin with a high level of transparency, mechanical strength, thermal stability, moisture blocking properties, isotropy, and the like may be used as a material for forming the transparent protective film. Examples of such a thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic olefin polymer resins (norbornene resins), polyarylate resins, polystyrene resins, polyvinyl alcohol resins, and any mixture thereof. The transparent protective film is generally laminated to one side of the polarizing film with the adhesive layer, but thermosetting resins or ultraviolet curing resins such as (meth)acrylic, urethane, acrylic urethane, epoxy, or silicone resins may be used to other side of the polarizing film for the transparent protective film. The transparent protective film may also contain at least one type of any appropriate additive. Examples of the additive include an ultraviolet absorbing agent, an antioxidant, a lubricant, a plasticizer, a release agent, an anti-discoloration agent, a flame retardant, a nucleating agent, an antistatic agent, a pigment, and a colorant. The content of the thermoplastic resin in the transparent protective film is preferably from 50 to 100% by weight, more preferably from 50 to 99% by weight, still more preferably from 60 to 98% by weight, particularly preferably from 70 to 97% by weight. If the content of the thermoplastic resin in the transparent protective film is 50% by weight or less, high transparency and other properties inherent in the thermoplastic resin can fail to be sufficiently exhibited.

Moreover, as is described in JP-A No. 2001-343529 (WO 01/37007), polymer films, for example, resin compositions including (A) thermoplastic resins having substituted and/or non-substituted imido group in sidechain, and (B) thermoplastic resins having substituted and/or non-substituted phenyl and nitrile group in sidechain may be mentioned. As an illustrative example, a film may be mentioned that is made of a resin composition including alternating copolymer comprising iso-butylene and N-methyl maleimide, and acrylonitrile-styrene copolymer. A film comprising mixture extruded article of resin compositions etc. may be used. Since the films are less in retardation and less in photoelastic coefficient, faults such as unevenness due to a strain in a polarizing plate can be removed and besides, since they are less in moisture permeability, they are excellent in durability under humidified environment.

Thickness of the transparent protective film can be properly determined and generally in the range of from about 1 to about 500 μm from the viewpoint of a strength, workability such as handlability, requirement for a thin film and the like. Especially, the thickness is preferably in the range of from 1 to 300 μm and more preferably in the range of from 5 to 200 μm. Therefore, it is particularly preferred that the transparent protective film has a thickness of 5 to 150 μm.

Note that in a case where the transparent protective films are provided on both sides of the polarizing film, the protective films made from the same polymer may be used on both sides thereof or alternatively, the protective films made from polymer materials different from each other may also be used on respective both sides thereof.

At least one selected from a cellulose resin, a polycarbonate resin, a cyclic polyolefin resin, and a (meth)acrylic resin is preferably used for the transparent protective film according to the invention.

The cellulose resin is an ester of cellulose and a fatty acid. Examples of such a cellulose ester resin include triacetyl cellulose, diacetyl cellulose, tripropionyl cellulose, dipropionyl cellulose, and the like. In particular, triacetyl cellulose is preferred. Much commercially available triacetyl celluloses are placing on sale and are advantageous in view of easy availability and cost. Examples of commercially available products of triacetyl cellulose include UV-50, UV-80, SH-80, TD-80U, TD-TAC, and UZ-TAC (trade names) manufactured by Fujifilm Corporation, and KC series manufactured by Konica Minolta. In general, these triacetyl cellulose products have thickness direction retardation (Rth) of about 60 nm or less, while having in-plane retardation (Re) of almost zero.

For example, the cyclic polyolefin resin is preferably a norbornene resin. Cyclic olefin resin is a generic name for resins produced by polymerization of cyclic olefin used as a polymerizable unit, and examples thereof include the resins disclosed in JP-A Nos. 01-240517, 03-14882, and 03-122137. Specific examples thereof include ring-opened (co)polymers of cyclic olefins, addition polymers of cyclic olefins, copolymers (typically random copolymers) of cyclic olefins and α-olefins such as ethylene and propylene, graft polymers produced by modification thereof with unsaturated carboxylic acids or derivatives thereof, and hydrogenated products thereof. Examples of the cyclic olefin include norbornene monomers.

Various commercially available cyclic polyolefin resins are placing on sale. Examples thereof include Zeonex (trade name) and Zeonor (trade name) series manufactured by Zeon Corporation, Arton (trade name) series manufactured by JSR Corporation, Topas (trade name) series manufactured by Ticona, and Apel (trade name) series manufactured by Mitsui Chemicals, Inc.

The (meth)acrylic resin preferably has a glass transition temperature (Tg) of 115° C. or more, more preferably of 120° C. or more, still more preferably of 125° C. or more, particularly preferably of 130° C. or more. If the Tg is 115° C. or more, the resulting polarizing plate can have good durability. The upper limit to the Tg of the (meth)acrylic resin is preferably, but not limited to, 170° C. or less, in view of formability and the like. The (meth)acrylic resin can form a film with in-plane retardation (Re) of almost zero and thickness direction retardation (Rth) of almost zero.

Any appropriate (meth)acrylic resin may be used as long as the advantages of the invention are not reduced. Examples of such a (meth)acrylic resin include poly(meth)acrylate such as poly(methyl methacrylate), methyl methacrylate-(meth)acrylic acid copolymers, methyl methacrylate-(meth)acrylate copolymers, methyl methacrylate-acrylate-(meth)acrylic acid copolymers, methyl (meth)acrylate-styrene copolymers (such as MS resins), and alicyclic hydrocarbon group-containing polymers (such as methyl methacrylate-cyclohexyl methacrylate copolymers and methyl methacrylate-norbornyl (meth)acrylate copolymers). Poly(C₁₋₆ alkyl (meth)acrylate) such as poly(methyl (meth)acrylate) is preferred, and a methyl methacrylate-based resin mainly composed of a methyl methacrylate unit (50 to 100% by weight, preferably 70 to 100% by weight) is more preferred.

Examples of the (meth)acrylic resin include Acrypet VH and Acrypet VRL20A each manufactured by Mitsubishi Rayon Co., Ltd., (meth)acrylic resins having a ring structure in their molecule as disclosed in JP-A No. 2004-70296, and high-Tg (meth)acrylic resins produced by intramolecular crosslinking or intramolecular cyclization reaction.

Lactone ring structure-containing (meth)acrylic resins may also be used, because they have high heat resistance and high transparency and also have high mechanical strength after biaxially stretched.

Examples of the lactone ring structure-containing (meth)acrylic reins include the lactone ring structure-containing (meth)acrylic reins disclosed in JP-A Nos. 2000-230016, 2001-151814, 2002-120326, 2002-254544, and 2005-146084.

The transparent protective film to be used generally has an in-plane retardation of less than 40 nm and a thickness direction retardation of less than 80 nm. The in-plane retardation Re is expressed by the formula Re=(nx−ny)×d, the thickness direction retardation Rth is expressed by the formula Rth=(nx−nz)×d, and the Nz coefficient is represented by the formula Nz=(nx−nz)/(nx−ny), where nx, ny and nz are the refractive indices of the film in the directions of its slow axis, fast axis and thickness, respectively, d is the thickness (nm) of the film, and the direction of the slow axis is a direction in which the in-plane refractive index of the film is maximum. Moreover, it is preferable that the transparent protective film may have as little coloring as possible. A protective film having a thickness direction retardation of from −90 nm to +75 nm may be preferably used. Thus, coloring (optical coloring) of polarizing plate resulting from a protective film may mostly be cancelled using a protective film having a thickness direction retardation (Rth) of from −90 nm to +75 nm. The thickness direction retardation (Rth) is preferably from −80 nm to +60 nm, and especially preferably from −70 nm to +45 nm.

Alternatively, the transparent protective film to be used may be a retardation plate having an in-plane retardation of 40 nm or more and/or a thickness direction retardation of 80 nm or more. The in-plane retardation is generally controlled in the range of 40 to 200 nm, and the thickness direction retardation is generally controlled in the range of 80 to 300 nm. The retardation plate for use as the transparent protective film also has the function of the transparent protective film and thus can contribute to a reduction in thickness.

The transparent protective film may be subjected to surface modification treatment before it is applied with the adhesive. Specific examples of such treatment include corona treatment, plasma treatment, primer treatment, saponification treatment, etc.

A hard coat layer may be prepared, or antireflection processing layer, processing aiming at sticking prevention, diffusion or anti glare may be performed onto the face on which the polarizing film of the above described transparent protective film has not been adhered.

In addition, the above-mentioned antireflection layer, sticking prevention layer, diffusion layer, anti glare layer, etc. may be built in the protective film itself, and also they may be prepared as an optical layer different from the protective film.

The polarizing plate of the invention is manufactured by bonding the transparent protective film and the polarizing film together with the adhesive. The manufacturing method includes the steps of: applying the adhesive to the adhesive layer-receiving surface of the polarizing film and/or the adhesive layer-receiving surface of the transparent protective film; and bonding the polarizing film and the transparent protective film together with the polarizing plate adhesive interposed therebetween.

In an embodiment of the invention, a polarizing plate may be used in practical use as an optical film laminated with other optical layers. Although there is especially no limitation about the optical layers, one layer or two layers or more of optical layers, which may be used for formation of a liquid crystal display etc., such as a reflector, a transflective plate, a retardation plate (a half wavelength plate and a quarter wavelength plate included), and a viewing angle compensation film, may be used.

Although an optical film with the above described optical layer laminated to the polarizing plate may be formed by a method in which laminating is separately carried out sequentially in manufacturing process of a liquid crystal display etc., an optical film in a form of being laminated beforehand has an outstanding advantage that it has excellent stability in quality and assembly workability, etc., and thus manufacturing processes ability of a liquid crystal display etc. may be raised. Proper adhesion means, such as an adhesive layer, may be used for laminating. On the occasion of adhesion of the above described polarizing plate and other optical films, the optical axis may be set as a suitable configuration angle according to the target retardation characteristics etc.

In the polarizing plate mentioned above and the optical film in which at least one layer of the polarizing plate is laminated, a pressure-sensitive adhesive layer may also be prepared for adhesion with other members, such as a liquid crystal cell etc. As pressure-sensitive adhesive that forms pressure-sensitive layer is not especially limited, and, for example, acrylic type polymers; silicone type polymers; polyesters, polyurethanes, polyamides, polyethers; fluorine type and rubber type polymers may be suitably selected as a base polymer. Especially, a pressure-sensitive adhesive such as acrylics type pressure-sensitive adhesives may be preferably used, which is excellent in optical transparency, showing adhesion characteristics with moderate wettability, cohesiveness and adhesive property and has outstanding weather resistance, heat resistance, etc.

A temporary separator is attached to an exposed side of a pressure-sensitive adhesive layer to prevent contamination etc., until it is practically used. Thereby, it can be prevented that foreign matter contacts pressure-sensitive adhesive layer in usual handling. As a separator, without taking the above-mentioned thickness conditions into consideration, for example, suitable conventional sheet materials that is coated, if necessary, with release agents, such as silicone type, long chain alkyl type, fluorine type release agents, and molybdenum sulfide may be used. As a suitable sheet material, plastics films, rubber sheets, papers, cloths, no woven fabrics, nets, foamed sheets and metallic foils or laminated sheets thereof may be used.

In an embodiment of the invention, the polarizing plate is preferably used in a variety of image displays such as liquid crystal displays and organic electroluminescence devices. When used in a liquid crystal display, the polarizing plates according to an embodiment of the invention are placed on the front and back surfaces of a liquid crystal cell so that their light transmission axes are perpendicular to each other. This arrangement reduces light leakage in the visible wavelength region and makes it possible to obtain a liquid crystal display device that is prevented from causing discoloration on the display screen. The liquid crystal cell to be used may be of any type such as a TN, STN, n, VA, or IPS type.

### EXAMPLES

Preferred examples of the invention are illustratively described in detail below. It will be understood that the materials, the contents of the materials, and other features described in the examples are not intended to limit the scope of the invention, unless otherwise stated.

### Example 1

### [Preparation of PVA Film]

A raw PVA film (trade name: VF-PS750, manufactured by KURARAY CO., LTD.) was provided. The PVA film had a length of 200 m, a width of 540 mm, and a thickness of 75 μm. Using a tenter stretching machine, the PVA film was held by tenter clips (holding parts) at both transverse ends, and subjected to each step described below, while being fed in its longitudinal direction. The held portion held by each tenter clip had a length of 25 mm and a width of 50 mm. The distance between the tenter clips adjacent in the longitudinal direction of the PVA film was 5 mm.

### [Fabrication of Polarizing Film]

A swelling step, a dyeing step, a crosslinking step, a stretching step, a control step, and a drying step were sequentially performed using the fabricating apparatus of the invention shown in FIG. 1. More specifically, the steps were performed as described below. The treatment tanks for use in the swelling step, the dyeing step, the crosslinking step, the stretching step, and the control step, respectively, were arranged in order between the rails on which the holding parts traveled. The transverse length of the region to be treated of the PVA film was as shown in Table 1 below, immediately before the film was fed to each step. In Table 1, the term “free part” means a state in which the PVA film is released from being held by the holding parts. The PVA film feed speed was 2.5 m/minute, and the depth of the treatment liquid in each treatment tank was 150 mm (see Table 2 below).

TABLE 1
Transverse length (mm) of region to be treated

| | | | Cross- | | | |
|---|---|---|---|---|---|---|
| Chucking | Swelling | Dyeing | linking | Stretching | Control | Free |
| part | step | step | step | step | step | part |
| 520 | 520 | 854 | 1158 | 1385 | 2000 | 2000 |

### (1) Swelling Step

In this step, a treatment tank was filled with a swelling liquid (water at a temperature of 30° C.). The PVA film was brought into contact with the swelling liquid for a time period of 150 seconds to be allowed to swell, while being stretched transversely. The transverse stretch ratio reached 2 times the width of the unstretched PVA film.

### (2) Dyeing Step

In this step, a treatment tank was filled with a dyeing liquid (a 0.2% by weight of iodine aqueous solution (containing 0.07% by weight of KI) at a temperature of 25° C.). The PVA film was brought into contact with the dyeing liquid for a time period of 100 seconds to be dyed, while being stretched transversely. The transverse stretch ratio reached 2.8 times the width of the unstretched PVA film.

### (3) Crosslinking Step

In this step, a treatment tank was filled with a crosslinking liquid (an aqueous solution containing 2.5% by weight of boric acid and 2% by weight of KI, at a temperature of 35° C.). The PVA film was brought into contact with the crosslinking liquid for a time period of 50 seconds. The transverse stretch ratio reached 3.4 times the width of the unstretched PVA film.

### (4) Transverse Stretching Step

In this step, a treatment tank was filled with a stretching liquid (an aqueous solution containing 2.5% by weight of boric acid and 2% by weight of KI, at a temperature of 35° C.). The PVA film was brought into contact with the stretching liquid for a time period of 150 seconds. The transverse stretch ratio reached 5.2 times the width of the unstretched PVA film.

### (5) Control Step

In this step, a treatment tank was filled with a control liquid (a 2.5% by weight of hydrogen iodide aqueous solution, at a temperature of 30° C.). The PVA film was brought into contact with the control liquid for a time period of 15 seconds.

### (6) Drying Step

In this step, the PVA film after the control step was dried at a temperature of 60° C. for a time period of 250 seconds. Subsequently, the PVA film was cut at both ends so as to have a final width of 1,600 mm, and the product was wound together with a polyethylene terephthalate inserting sheet. As a result, a polarizing film roll was obtained.

TABLE 2

| | | Treat- | | | |
|---|---|---|---|---|---|
| | | ment | Treatment | | Transverse |
| | Treatment | liquid | liquid | Contact | stretch |
| | liquid | temper- | viscosity | time | ratio |
| Step | (wt %) | ature | (mm²/S) | (seconds) | (times) |
| Swelling | Water | 30 | 0.8 | 150 | 2 |
| step | | | | | |
| Dyeing step | 0.2% iodine | 25 | 0.8 | 100 | 2.8 |
| | aqueous | | | | |
| | solution | | | | |
| | (containing | | | | |
| | 0.07% KI) | | | | |
| Crosslinking | Aqueous | 35 | 0.7 | 50 | 3.4 |
| step | solution of | | | | |
| | 2.5% boric | | | | |
| | acid and | | | | |
| | 2% KI | | | | |
| Stretching | Aqueous | 35 | 0.7 | 150 | 5.2 |
| step | solution of | | | | |
| | 2.5% boric | | | | |
| | acid and | | | | |
| | 2% KI | | | | |
| Control step | 2.5% KI | 30 | 0.65 | 15 | 5.2 |
| | aqueous | | | | |
| | solution | | | | |

### [Fabrication of Polarizing Plate]

Using a laminator, a polarizing plate was fabricated by bonding triacetylcellulose films (trade name: TD80UL, manufactured by FUJIFILM Corporation) to both sides of the polarizing film with a PVA-based adhesive (trade name: NH18, manufactured by Nippon Synthetic Chemical Industry Co., Ltd.) interposed therebetween. The bonding temperature was 25° C. Subsequently, the laminate after the bonding was dried under the conditions of 55° C. and a time period of 300 seconds using an air-circulation type thermostatic oven. As a result, a polarizing plate according to this example was obtained.

### Examples 2 to 8

In each of Examples 2 to 8, a polarizing plate was fabricated as in Example 1, except that the depth of the treatment liquid in the treatment tank used in each of the swelling step, the dyeing step, the crosslinking step, the stretching step, and the control step was changed as shown in Table 3 below.

### Comparative Example 1

[Preparation of PVA Film]

The same raw PVA film as in Example 1 was provided. In each step, transverse stretching was performed using a tenter stretching machine as in Example 1. The length and the width of the held portion held by each tenter clip, and the distance between the tenter clips adjacent in the longitudinal direction of the PVA film were also the same as those in Example 1.

### [Fabrication of Polarizing Film]

### (1) Swelling Step

Water (a swelling liquid at a temperature of 30° C.) was sprayed on the lower surface of the PVA film for 100 seconds so that the PVA film was allowed to swell while being stretched transversely. The distance between the spray nozzle and the PVA film was 30 cm, and the swelling liquid was sprayed in an amount of 1.0 mL/1 cm² on the PVA film. The spray device used was T-AFPV (trade name) manufactured by DeVilbiss. The transverse stretch ratio reached 2 times the width of the unstretched PVA film. The spraying time, which was calculated from the spray area and the feed speed, indicates the time period for which the spray is applied to any point on the film.

### (2) Dyeing Step

After the swelling, a dyeing liquid (a 0.2% by weight of iodine aqueous solution (containing 0.07% by weight of KI) at a temperature of 25° C.) was sprayed on the lower surface of the PVA film for 45 seconds so that the PVA film was dyed while being stretched transversely. The distance between the spray nozzle and the PVA film was 30 cm, and the dyeing liquid was sprayed in an amount of 1.0 mL/1 cm² on the PVA film. The spray device used was the same as that used in the swelling step. The transverse stretch ratio reached 2.8 times the width of the unstretched PVA film.

### (3) Crosslinking Step

After the dyeing, a crosslinking liquid (an aqueous solution containing 2.5% by weight of boric acid and 2% by weight of KI, at a temperature of 35° C.) was sprayed on the lower surface of the PVA film for 35 seconds. The distance between the spray nozzle and the PVA film was 30 cm, and the crosslinking liquid was sprayed in an amount of 1 mL/1 cm² on the PVA film. The spray device used was the same as that used in the swelling step. The transverse stretch ratio reached 3.4 times the width of the unstretched PVA film.

### (4) Transverse Stretching Step

After the crosslinking, a stretching liquid (an aqueous solution containing 2.5% by weight of boric acid and 2% by weight of KI, at a temperature of 35° C.) was sprayed on the lower surface of the PVA film for 60 seconds, while the PVA film was stretched transversely. The distance between the spray nozzle and the PVA film was 30 cm, and the crosslinking liquid was sprayed in an amount of 0.6 mL/1 cm² on the PVA film. The spray device used was the same as that used in the swelling step. The transverse stretch ratio reached 5.2 times the width of the unstretched PVA film.

### (5) Control Step

After the crosslinking, a stretching liquid (an aqueous solution containing 2.5% by weight of boric acid and 2% by weight of KI, at a temperature of 35° C.) was sprayed on the lower surface of the PVA film for 15 seconds. The distance between the spray nozzle and the PVA film was 30 cm, and the crosslinking liquid was sprayed in an amount of 0.6 mL/1 cm² on the PVA film. The spray device used was the same as that used in the swelling step.

### (6) Drying Step

The drying step was performed as in Example 1.

### [Fabrication of Polarizing Plate]

In Comparative Example 1, a polarizing plate was fabricated as in Example 1.

### Comparative Example 2

In Comparative Example 2, a polarizing film was fabricated as in Comparative Example 1, except that in the dyeing step, the spray area in the direction of feeding of the dyeing liquid was changed to twice that in Comparative Example 1, and therefore, the dyeing liquid-spraying time was changed to twice (90 seconds). A polarizing plate was also fabricated as in Comparative Example 1.

### Comparative Example 3

### [Preparation of PVA Film]

The same raw PVA film as in Example 1 was provided. In each step, transverse stretching was performed using a tenter stretching machine as in Example 1. The length and the width of the held portion held by each tenter clip, and the distance between the tenter clips adjacent in the longitudinal direction of the PVA film were also the same as those in Example 1.

### [Fabrication of Polarizing Film]

### (1) Swelling Step

Water (a swelling liquid at a temperature of 30° C.) was applied by coating to the upper surface of the PVA film so that the PVA film was allowed to swell while being stretched transversely. The coating time (the time period for which the swelling liquid was brought into contact) was 45 seconds. The coating rate was 2.3 ml/second. The coating device used was a die coater. The transverse stretch ratio reached 2 times the width of the unstretched PVA film.

### (2) Dyeing Step

After the swelling, a dyeing liquid (a 0.2% by weight of iodine aqueous solution (containing 0.07% by weight of KI) at a temperature of 25° C.) was applied by coating to the upper surface of the PVA film so that the PVA film was dyed while being stretched transversely. The coating time (the time period for which the dyeing liquid was brought into contact) was 45 seconds. The coating rate was 3.7 ml/second. The coating device used was the same as that used in the swelling step. The transverse stretch ratio reached 2.8 times the width of the unstretched PVA film.

### (3) Crosslinking Step

After the dyeing, a crosslinking liquid (an aqueous solution containing 2.5% by weight of boric acid and 2% by weight of KI, at a temperature of 35° C.) was applied by coating to the upper surface of the PVA film. The coating time (the time period for which the crosslinking liquid was brought into contact) was 45 seconds. The coating rate was 5.5 ml/second. The coating device used was also the same as that used in the swelling step. The transverse stretch ratio reached 3.4 times the width of the unstretched PVA film.

### (4) Transverse Stretching Step

After the crosslinking, a stretching liquid (an aqueous solution containing 2.5% by weight of boric acid and 2% by weight of KI, at a temperature of 35° C.) was applied by coating to the upper surface of the PVA film, while the PVA film was stretched transversely. The coating time (the time period for which the stretching liquid was brought into contact) was 45 seconds. The coating rate was 7.3 ml/second. The coating device used was also the same as that used in the swelling step. The transverse stretch ratio reached 5.2 times the width of the unstretched PVA film.

### (5) Control Step

After the crosslinking, a stretching liquid (an aqueous solution containing 2.5% by weight of boric acid and 2% by weight of KI, at a temperature of 35° C.) was applied by coating to the upper surface of the PVA film. The coating time (the time period for which the control liquid was brought into contact) was 45 seconds. The coating rate was 9.2 ml/second. The coating device used was also the same as that used in the swelling step.

### (6) Drying Step

The drying step was performed as in Example 1.

### [Fabrication of Polarizing Plate]

In Comparative Example 3, a polarizing plate was fabricated as in Example 1.

### (Level of Unevenness of Polarizing Film)

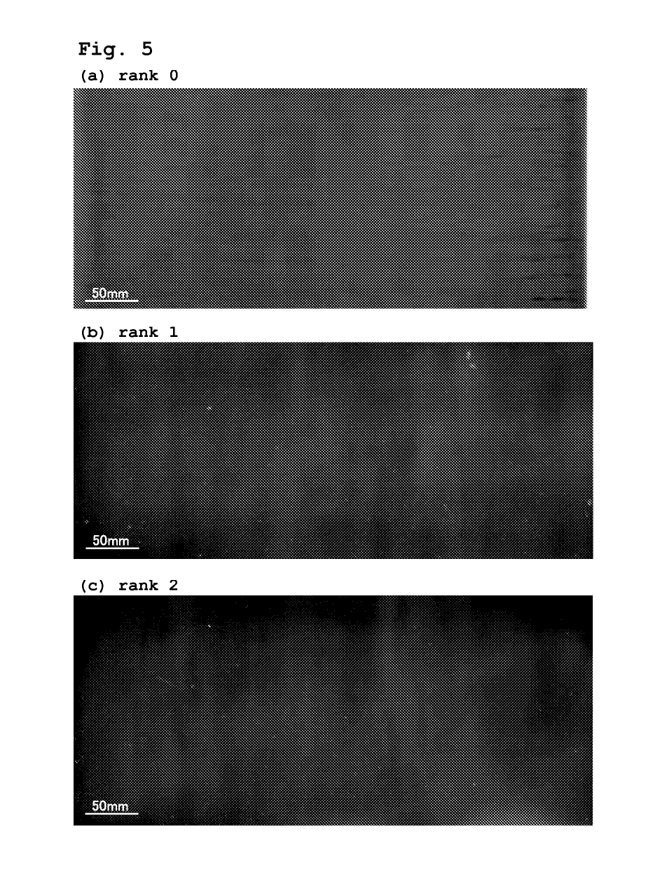

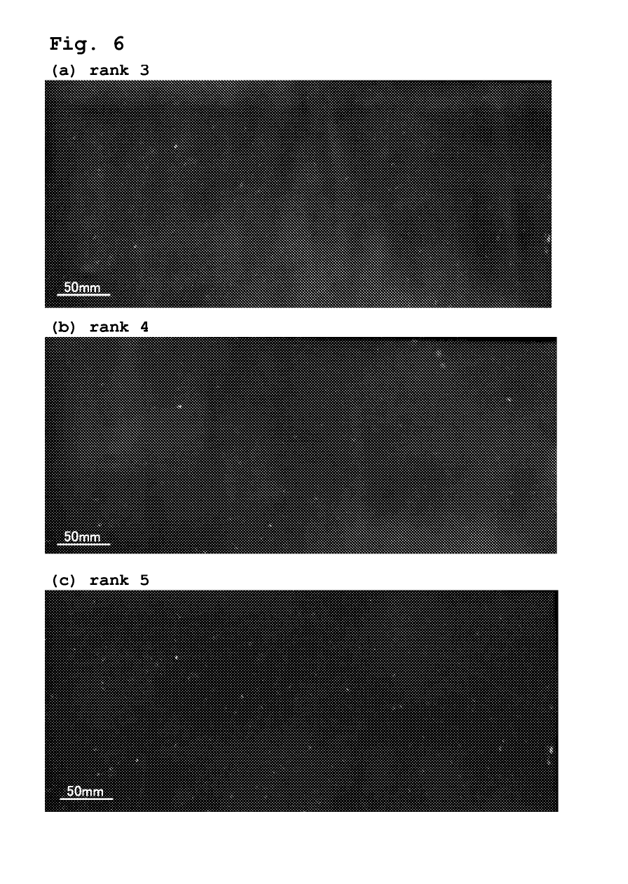

First, the polarizing film fabricated in each of Examples and Comparative Examples was evaluated for unevenness at three points on an arbitrary straight line along the transverse direction. Among the results of the evaluation, the worst result was used as the representative result on the straight line. The evaluation was further performed on different straight lines. The results are shown in Table 3 below. Table 3 shows the results of the evaluation of unevenness on the respective straight lines (n=1-3). In the evaluation, the level of unevenness was classified into six grades, from rank 0 to rank 5 (see FIGS. 5(a)-5(c) and FIGS. 6(a)-6(c)). In the vertical direction to the polarizing film, the case where unevenness was observed from a distance of 2 m under daylight conditions was evaluated as rank 0; the case where unevenness was observed from a distance of 50 cm under daylight conditions was evaluated as rank 1; the case where unevenness was intensely observed from a distance of 50 cm under dark conditions was evaluated as rank 2; the case where unevenness was weakly observed from a distance of 50 cm under dark conditions was evaluated as rank 3; the case where unevenness was observed from a distance of 30 cm under dark conditions was evaluated as rank 4; the case where unevenness was not observed from a distance of 30 cm under dark conditions was evaluated as rank 5.

### (Amount of Adsorbed Iodine)

The amount of adsorbed iodine in the polarizing film fabricated in each of Examples and the Comparative Examples was determined using X-ray fluorescence analysis (product name: XRF Model ZSX100-e, manufactured by Rigaku Corporation). The results are shown in Table 3 below.

### (Results)

Table 3 below shows that in the polarizing plates of Examples 1 to 8, a sufficient amount of adsorbed iodine is present and the occurrence of light leakage is successfully reduced. In the polarizing plates of Examples 1 to 5, the occurrence of unevenness is successfully further reduced. In contrast, it was found that unevenness significantly occurred when a polarizing film was fabricated by a spraying method as in the case of the fabrication of a polarizing plate in Comparative Examples 1 and 2. It was also found that when a coating method was used, the occurrence of unevenness was slightly reduced, but the amount of adsorbed iodine was relatively small, and it was difficult to reduce the occurrence of light leakage.

TABLE 3

| | | | | Depth A | | | | | Amount |
|---|---|---|---|---|---|---|---|---|---|
| | | Contact | Feed | (mm) of | | | | | (wt %) of |
| | Treatment | time | speed B | treatment | B/A | Unevenness level | | | adsorbed |
| | method | (sec) | (m/min) | liquid | (1/min) | n = 1 | n = 2 | n = 3 | iodine |
| Example 1 | Contact | 100 | 2.5 | 750 | 3.3 | 5 | 5 | 4 | 2.702 |
| | method | | | | | | | | |
| Example 2 | Contact | 100 | 2.5 | 500 | 5.0 | 4 | 4 | 3 | 2.769 |
| | method | | | | | | | | |
| Example 3 | Contact | 100 | 2.5 | 375 | 6.7 | 3 | 4 | 4 | 2.633 |
| | method | | | | | | | | |
| Example 4 | Contact | 100 | 2.5 | 250 | 10.0 | 4 | 3 | 3 | 2.527 |
| | method | | | | | | | | |
| Example 5 | Contact | 100 | 2.5 | 175 | 14.3 | 3 | 3 | 4 | 2.578 |
| | method | | | | | | | | |
| Example 6 | Contact | 100 | 2.5 | 130 | 19.2 | 3 | 2 | 3 | 2.539 |
| | method | | | | | | | | |
| Example 7 | Contact | 100 | 2.5 | 100 | 25.0 | 2 | 2 | 2 | 2.782 |
| | method | | | | | | | | |
| Example 8 | Contact | 100 | 2.5 | 50 | 50.0 | 1 | 1 | 2 | 2.773 |
| | method | | | | | | | | |
| Comparative | Spraying | 45 | 2.5 | — | — | 0 | 0 | 0 | 1.239 |
| Example 1 | method | | | | | | | | |
| Comparative | Spraying | 90 | 2.5 | — | — | 0 | 0 | 0 | 2.482 |
| Example 2 | method | | | | | | | | |
| Comparative | Coating | 45 | 2.5 | — | — | 2 | 1 | 2 | 0.837 |
| Example 3 | method | | | | | | | | |

### DESCRIPTION OF REFERENCE SIGNS

In the drawings, reference sign 1 represents an optical film-fabricating apparatus, 11a roll, 12 holding parts, 13 a treatment tank, 13a to 13e each a treatment tank, 21a film, and 22 a region to be treated.

1. A method for fabricating an optical film, comprising a treatment step comprising: continuously feeding a film, while holding both transverse end portions of the film; and bringing a lower surface of the film into contact with a surface of a treatment liquid with which a treatment tank is filled, while continuously feeding the film.

2. The method according to claim 1, wherein the treatment step further comprises sequentially stretching the film in its transverse direction.

3. The method according to claim 1, wherein the treatment liquid has a viscosity of at most 100 mPa·s, and the relation B/A<18 (l/minute) is satisfied, wherein A represents the depth (mm) of the treatment liquid in the treatment tank, and B represents a speed (mm/minute) at which the film is fed.

4. The method according to claim 1, wherein the lower surface of the film brought into contact with the treatment liquid is a region inside the holding parts located at both ends of the film.

5. The method according to claim 1, wherein the treatment liquid used contains water and at least a dichroic material or a crosslinking agent.

6. The method according to claim 1, wherein the treatment liquid is continuously supplied to the treatment tank.

7. An apparatus for fabricating an optical film, comprising:
a plurality of pairs of holding parts for continuously feeding a film while holding both transverse end portions of the film so that the film is allowed to continuously pass through a certain treatment step; and
a treatment tank filled with a treatment liquid for use in a certain treatment of the film, wherein
the plurality of pairs of holding parts are arranged at certain intervals along the longitudinal direction of the film,
each pair of holding parts are configured to transversely stretch the film by moving away from each other while feeding the film, and
the treatment tank is placed below the film to be fed so that the film can be treated by bringing a lower surface of the film into contact with the treatment liquid.

8. The apparatus according to claim 7, which satisfies the relation B/A<18 (l/minute), wherein A represents the depth (mm) of the treatment liquid in the treatment tank, and B represents a speed (mm/minute) at which the film is fed.

9. The apparatus according to claim 7, wherein the treatment tank has a width smaller than the width of the film so that the lower surface of the film to be in contact with the treatment liquid is a region inside both ends of the film.

10. The apparatus according to claim 7, further comprising a treatment liquid supply unit for continuously supplying the treatment liquid to the treatment tank.
